(19) United States
(12) Patent Application Publication
(10) Pub. No.: US 2013/0271833 A1
(43) Pub. Date: Oct. 17, 2013

(54) RESIN COMPOSITION, PHASE-CONTRAST FILM, METHOD FOR MANUFACTURING PHASE-CONTRAST FILM, AND LONG CIRCULARLY-POLARIZING PLATE

(71) Applicant: Taku Hatano, Tokyo (JP)

(72) Inventor: Taku Hatano, Tokyo (JP)

(73) Assignee: ZEON CORPORATION, Tokyo (JP)

(21) Appl. No.: 13/976,368

(22) PCT Filed: Dec. 27, 2011
(86) PCT No.: PCT/JP2011/080205

§ 371 Date: Jun. 26, 2013

(30) Foreign Application Priority Data
Dec. 28, 2010 (JP) 2010-291675

(51) Int. Cl. G02B 1/08; B29C 55/12; B29C 55/02

(52) U.S. Cl. CPC G02B 1/08; B29C 55/02; B29C 55/12
USPC 359/483.01; 252/582; 264/291; 264/288.4

(57) ABSTRACT

A resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.

### FIELD

The present invention relates to a resin composition, a phase difference film using the resin composition and a method for manufacturing the phase difference film, as well as a long-length circular polarizing plate using the phase difference film.

### BACKGROUND

In a display device such as a liquid crystal display device, a phase difference film is sometimes used in order to, e.g., correct retardation (phase difference). It is known that, as the phase difference film, a stretched film which is obtained by stretching a long-length pre-stretch film formed from a resin in an MD direction (machine direction) or in a TD direction (traverse direction) to give orientation to the molecules contained in the film, can be easily manufactured and thus preferable. The MD direction herein refers to a direction in which the film flows in a manufacturing line. The MD direction is usually the same as the lengthwise direction of the long-length film, and is also called a longitudinal direction. Furthermore, the TD direction is a direction that is parallel to the film surface and is orthogonal to the MD direction. The TD direction is also usually called a crosswise direction or a width direction.

Regarding the phase difference film, attempts have been made to control optical performance of the phase difference film by adjusting, e.g., the type of the resin for use (see Patent Literatures 1 to 3). For example, it is known that a phase difference film having inverse wavelength distribution can be realized by employing a resin composition in which specific two or more species of polymers are used in combination. The inverse wavelength distribution herein means the characteristics in which, as the wavelength of light transmitting the phase difference film becomes longer, an in-plane direction retardation imparted to the light becomes larger.

However, a conventional phase difference film had a problem regarding manufacturing efficiency and area size enlargement. Specifically, upon producing a product of the phase difference film in a rectangular shape, it is often required to give the product a slow axis in the diagonal direction with respect to the side direction of the rectangular. However, in the conventional general stretched film, the slow axis thereof is in the MD direction or in the TD direction. Therefore, when a rectangular product is cut out from the long-length stretched film, the rectangular film piece has to be cut out in a direction that is inclined diagonally with respect to the lengthwise direction, thereby causing a large amount of yield loss. Such loss causes low manufacturing efficiency, and hinders area size enlargement. Then, the applicant has proposed in Patent Literature 4 a phase difference film which can be easily manufactured at low cost and can have a large area size.

### CITATION LIST

### Patent Literature

Patent Literature 1: Japanese Patent Publication No. 3325560 B
Patent Literature 2: Japanese Patent Application Laid-Open No. 2001-42121 A
Patent Literature 3: Japanese Patent Application Laid-Open No. 2001-194527 A
Patent Literature 4: International Publication No. 2010/74166

### Summary

### Technical Problem

However, in the technique such as those disclosed in Patent Literature 4, there was a problem relating to heat resistance of the resulting phase difference film. In addition, a phase difference film is especially required to maintain the desired retardation. Therefore, in the attempt of improving heat resistance of the phase difference film having inverse wavelength distribution, it is also required to improve heat resistance while maintaining the inverse wavelength distribution. Furthermore, since the phase difference film is a type of optical films, it is also required to maintain a high level of transparency when improving heat resistance.

The present invention has been devised in view of the aforementioned problem, and an object of the present invention is to provide a resin composition with which a phase difference film having inverse wavelength distribution, high transparency and improved heat resistance that is better than the heat resistance of conventional phase difference films can be obtained, a phase difference film using the resin composition and a method for manufacturing the phase difference film, as well as a long-length circular polarizing plate using the phase difference film.

### Solution to Problem

The inventor has made intensive studies to solve the aforementioned problem. As a result, the inventor has found out that inverse wavelength distribution, high transparency and high heat resistance can be simultaneously realized by combining a polyphenylene ether (A) and a copolymer (B) containing a repeating unit derived from styrene compounds and a repeating unit derived from maleic acid anhydride, and further by limiting the amount of the repeating unit derived from maleic acid anhydride in the copolymer (B) and the ratio of the polyphenylene ether (A) relative to the repeating unit derived from styrene compounds to specific ranges. The present invention has thus been completed.

That is, the present invention is as the following (1) to (9).

(1) A resin composition comprising: a polyphenylene ether (A); and a copolymer (B) containing a repeating unit derived from a styrene compound and a repeating unit derived from maleic acid anhydride, wherein

an amount of the repeating unit derived from maleic acid anhydride in the copolymer (B) is equal to or larger than 5% by weight and equal to or smaller than 20% by weight, and

an amount of the polyphenylene ether (A) is equal to or more than 25 parts by weight and equal to or less than 35 parts by weight with respect to 100 parts by weight of the repeating unit derived from the styrene compound.

(2) A film obtained by molding the resin composition according to (1).
(3) A phase difference film obtained by stretching a pre-stretch film, the pre-stretch film consisting of the resin composition according to (1).
(4) A long-length phase difference film consisting of the resin composition according to (1),

the long-length phase difference film having an orientation angle in a range equal to or larger than 40° and equal to or smaller than 50° with respect to a lengthwise direction of the phase difference film.

(5) A phase difference film consisting of the resin composition according to (1),

wherein an in-plane direction retardation Re at a measurement wavelength of 550 nm is equal to or larger than 110 nm and equal to or smaller than 150 nm.

(6) The phase difference film according to any one of (3) to (5), wherein an in-plane direction retardation Re₄₅₀ at light having a wavelength of 450 nm, an in-plane direction retardation Re₅₅₀ at light having a wavelength of 550 nm, and an in-plane direction retardation Re₆₅₀ at light having a wavelength of 650 nm satisfy a relationship of Re₄₅₀<Re₅₅₀<Re₆₅₀.
(7) A method for manufacturing the phase difference film according to any one of (3) to (6), the method comprising stretching a pre-stretch film, the pre-stretch film being obtained by molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.
(8) A method for manufacturing the phase difference film according to (4), the method comprising stretching a long-length pre-stretch film in a diagonal direction with respect to a lengthwise direction of the long-length pre-stretch film, the long-length pre-stretch film being obtained by melt extrusion-molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.
(9) A long-length circular polarizing plate, obtained by laminating the long-length phase difference film according to (4) and a long-length polarizing plate having an absorption axis in a lengthwise direction.

### Advantageous Effects of Invention

According to the resin composition of the present invention, a phase difference film having inverse wavelength distribution, high transparency and improved heat resistance better than conventional phase difference films can be obtained.

According to the phase difference film and the method for manufacturing the phase difference film of the present invention, a phase difference film having inverse wavelength distribution, high transparency and also having improved heat resistance that is better than the heat resistance of conventional phase difference films can be realized.

According to the long-length circular polarizing plate of the present invention, it is possible to realize a circular polarizing plate, which is excellent in heat resistance and transparency, is not colored when used as an antireflective film, and can be easily manufactured.

### BRIEF DESCRIPTION OF DRAWINGS

FIG. 1 is a graph showing calculation results of the brightness of the reflected light in Example 1.

FIG. 2 is a graph showing calculation results of the color difference of the reflected light in Example 1.

FIG. 3 is a graph showing calculation results of the brightness of the reflected light in Example 2.

FIG. 4 is a graph showing calculation results of the color difference of the reflected light in Example 2.

FIG. 5 is a graph showing calculation results of the brightness of the reflected light in Example 3.

FIG. 6 is a graph showing calculation results of the color difference of the reflected light in Example 4.

FIG. 7 is a graph showing calculation results of the brightness of the reflected light in Comparative Example 4.

FIG. 8 is a graph showing calculation results of the color difference of the reflected light in Comparative Example 4.

FIG. 9 is a graph showing calculation results of the brightness of the reflected light in Comparative Example 5.

FIG. 10 is a graph showing calculation results of the color difference of the reflected light in Comparative Example 5.

### DESCRIPTION OF EMBODIMENTS

The present invention will be described in detail hereinbelow by showing embodiments and examples. However, the present invention is not limited to the following embodiments and examples, and may be optionally modified and implemented within a range that does not depart from the scope of claims of the present invention.

In the following description, each of the sign “(A)” of “polyphenylene ether (A)” and the sign “(B)” of “copolymer (B) containing a repeating unit derived from styrene compounds and a repeating unit derived from maleic acid anhydride” is a sign for distinguishing the element assigned with the sign from other elements, and does not have a meaning other than distinguishing one element from the other.

[1. Resin Composition]

The resin composition according to the present invention includes a polyphenylene ether (A), and a copolymer (B) which contains a repeating unit derived from a styrene compound (appropriately referred to hereinbelow as a “styrene compound unit”) and a repeating unit derived from maleic acid anhydride (appropriately referred to hereinbelow as a “maleic acid anhydride unit”).

[1-1. Polyphenylene Ether (A)]

The polyphenylene ether (A) is a polymer having a repeating unit derived from a phenylene ether or a phenylene ether derivative. As the polyphenylene ether (A), a polymer whose main chain has a repeating unit having a phenylene ether structure (appropriately referred to hereinbelow as a “phenylene ether unit”) is usually used. However, the benzene ring in the phenylene ether unit may have a substituent, as long as the effect of the present invention is not significantly impaired.

Especially, as the polyphenylene ether (A), a polymer containing a phenylene ether unit represented by the following formula (I) is preferable.

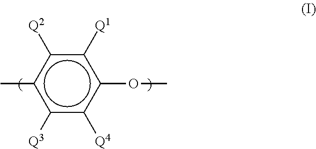

In the formula (I), each Q¹ independently represents a halogen atom, a lower alkyl group (for example, an alkyl group having 7 or less carbon atoms), a phenyl group, a haloalkyl group, an aminoalkyl group, a hydrocarbon oxy group, or a halohydrocarbon oxy group (with a proviso that the halogen atom and oxygen atom therein are separated by at least two carbon atoms). Especially, as the Q¹, an alkyl group and a phenyl group are preferable, and an alkyl group having 1 to 4 carbon atoms is particularly preferable.

In the formula (I), each Q² independently represents a hydrogen atom, a halogen atom, a lower alkyl group (for example, an alkyl group having 7 or less carbon atoms), a phenyl group, a haloalkyl group, a hydrocarbon oxy group, or a halohydrocarbon oxy group (with a proviso that the halogen atom and oxygen atom therein are separated by at least two carbon atoms). Especially, as the Q², a hydrogen atom is preferable.

The polyphenylene ether (A) may be a homopolymer having one species of structural unit, or may be a copolymer having two or more species of structural units.

When the polymer containing a structural unit represented by the formula (I) is a homopolymer, preferred examples of the homopolymer may include a homopolymer having a 2,6-dimethyl-1,4-phenylene ether unit (a repeating unit represented by “—(C₆H₂(CH₃)₂—O)—”).

When the polymer containing a structural unit represented by the formula (I) is a copolymer, preferred examples of the copolymer may include a random copolymer having a 2,6-dimethyl-1,4-phenylene ether unit and a 2,3,6-trimethyl-1,4-phenylene ether unit (i.e., a repeating unit represented by “—(C₆H(CH₃)₃—O—)—”.

The polyphenylene ether (A) may also contain a repeating unit other than the phenylene ether unit. In this case, the polyphenylene ether (A) becomes a copolymer having a phenylene ether unit and a structural unit other than the phenylene ether unit. However, it is preferable that the ratio of the structural unit other than the phenylene ether unit in the polyphenylene ether (A) is at a low level by which the effect of the present invention is not significantly impaired. The ratio is usually equal to or lower than 50% by weight, preferably equal to or lower than 30% by weight, more preferably equal to or lower than 20% by weight.

As the polyphenylene ether (A), one species thereof may be used alone, or two or more thereof may be used in combination at any ratio.

The weight average molecular weight of the polyphenylene ether (A) is usually equal to or more than 5,000, preferably equal to or more than 5,500, and more preferably equal to or more than 6,000, and usually equal to or less than 10,000, preferably equal to or less than 9,000, and more preferably equal to or less than 8,000. By using the polyphenylene ether (A) having such a low weight average molecular weight, the polyphenylene ether (A) and the copolymer (B) can be mixed in a highly uniform manner. Therefore, dispersibility of each polymer component in the resin composition of the present invention can be improved.

As the weight mean molecular weight, a standard polystyrene equivalent value is employed. The value is measured by a gel permeation chromatography (GPC) using tetrahydrofuran as a solvent at a temperature of 30° C.

The method for manufacturing the polyphenylene ether (A) is not limited, and the polyphenylene ether (A) may be manufactured by, e.g., the method described in Japanese Patent Application Laid-Open No. Hei. 11-302529 A.

[1-2. Copolymer (B)]

The copolymer (B) contains a styrene compound unit and a maleic acid anhydride unit.

The styrene compounds may include styrene and derivatives thereof. The styrene derivatives may be those having a substituent substituted at the benzene ring or the a position of styrene. Examples of the styrene compounds may include styrene; alkylstyrene such as methylstyrene and 2,4-dimethylstyrene; halogenated styrene such as chlorostyrene; halogen-substituted alkylstyrene such as chloromethylstyrene; alkoxystyrene such as methoxystyrene. Especially, as the styrene compound, styrene that does not have a substituent is preferable. As the styrene compound, one species thereof may be used alone, or two or more thereof may be used in combination at any ratio.

The amount of styrene compound units in the copolymer (B) is usually equal to or larger than 80% by weight, preferably equal to or larger than 83% by weight, and more preferably equal to or larger than 85% by weight, and usually equal to or smaller than 95% by weight, preferably equal to or smaller than 93% by weight, and more preferably equal to or smaller than 92% by weight. Usually, by limiting the amount of styrene compound units within such a range, the resulting phase difference film can express the desired retardation.

The amount of maleic acid anhydride units in the copolymer (B) is usually equal to or larger than 5% by weight, preferably equal to or larger than 7% by weight, and more preferably equal to or larger than 8% by weight, and usually equal to or smaller than 20% by weight, preferably equal to or smaller than 17% by weight, and more preferably equal to or lower than 15% by weight. By using the copolymer (B) containing the maleic acid anhydride units in an amount equal to or more than the lower limit value of the aforementioned range, the glass transition temperature of the copolymer (B) can be raised, and the glass transition temperature of the resin composition of the present invention can thereby be raised. Accordingly, heat resistance of the phase difference film can be improved. When the amount of maleic acid anhydride units is too large, dispersibility of the polyphenylene ether (A) and the copolymer (B) is reduced, and compatibility of these components may be deteriorated. Accordingly, the polymer components can cause, e.g., phase separation in the resin composition which can lead to haze deterioration. Therefore, the amount of maleic acid anhydride units is usually set to be equal to or smaller than the upper limit value of the aforementioned range.

The copolymer (B) may further contain a repeating unit other than the styrene compound unit and the maleic acid anhydride unit. However, it is preferable that the ratio of the repeating unit other than the styrene compound unit and the maleic acid anhydride unit in the copolymer (B) is at a low level by which the effect of the present invention is not significantly impaired. The ratio is usually equal to or lower than 15% by weight, preferably equal to or lower than 10% by weight, and more preferably equal to or lower than 5% by weight.

As the copolymer (B), one species thereof may be used alone, or two or more thereof may be used in combination at any ratio.

The weight average molecular weight of the copolymer (B) is usually equal to or more than 130,000, preferably equal to or more than 140,000, and more preferably equal to or more than 150,000, and usually equal to or less than 300,000, preferably equal to or less than 270,000, and more preferably equal to or less than 250,000. With such a weight average molecular weight, the copolymer (B) can have a high glass transition temperature, and heat resistance of the phase difference film can thereby be improved.

The glass transition temperature of the copolymer (B) is usually equal to or higher than 85° C., preferably equal to or higher than 90° C., and more preferably equal to or higher than 95° C. By using the copolymer (B) having such a high glass transition temperature, the glass transition temperature of the resin composition according to the present invention can be made higher effectively, and heat resistance of the phase difference film can be improved in a stable manner. However, excessively high glass transition temperature of a copolymer (B) may hinder easy manufacture of the phase difference film. Therefore, the temperature is usually equal to or lower than 160° C., preferably equal to or lower than 155° C., and more preferably equal to or lower than 150° C.

The method for manufacturing the copolymer (B) is not limited, and the copolymer (B) may be manufactured by, e.g., suspension polymerization, emulsion polymerization, and bulk polymerization.

In the resin composition of the present invention, the amount of the polyphenylene ether (A) with respect to 100 parts by weight of a styrene compound unit contained in the copolymer (B) is usually equal to or larger than 25 parts by weight, preferably equal to or larger than 26 parts by weight, and more preferably equal to or larger than 27 parts by weight, and usually equal to or smaller than 35 parts by weight, preferably equal to or smaller than 34 parts by weight, and more preferably equal to or smaller than 33 parts by weight. Of the components contained in the resin composition according to the present invention, the polyphenylene ether (A) has a positive intrinsic birefringence value, and the styrene compound unit contained in the copolymer (B) has a negative intrinsic birefringence value. Therefore, when the ratio of the polyphenylene ether (A) and the styrene compound unit falls in the aforementioned appropriate range, the positive intrinsic birefringence value that the polyphenylene ether (A) has and the negative intrinsic birefringence value that the styrene compound unit has are balanced, to thereby enable expression of inverse wavelength distribution.

[1-3. Other Components]

As long as the effect of the present invention is not significantly impaired, the resin composition of the present invention may contain a component other than the polyphenyl ether (A) and the copolymer (B).

For example, the resin composition of the present invention may contain a polymer other than the aforementioned polyphenyl ether (A) and copolymer (B). The amount of the resin other than the polyphenyl ether (A) and the copolymer (B) relative to the total amount of the polyphenyl ether (A) and the copolymer (B) being 100 parts by weight is preferably equal to or smaller than 15 parts by weight, more preferably equal to or smaller than 10 parts by weight, particularly preferably equal to or smaller than 5 parts by weight, and ideally zero.

The resin composition according to the present invention may also contain, e.g., an additive. Examples of the additive may include antifriction agents; layered crystalline compounds; inorganic particulates; stabilizers such as antioxidants, thermal stabilizers, light stabilizers, weathering stabilizers, ultraviolet absorbers and near-infrared absorbers; plasticizers: coloring agents such as dyes and pigments; and antistatic agents. As the additive, one species thereof may be used alone, or two or more thereof may be used in combination at any ratio.

The amount of the additive may be appropriately determined within the range of not significantly impairing the effect of the present invention. For example, the amount may be within the range in which the total light transmittance of the phase difference film of the present invention can be maintained at 85% or higher.

Among the aforementioned additives, antifriction agents and ultraviolet absorbers are preferable, since with them flexibility and weather resistance can be improved.

Examples of the antifriction agents may include inorganic particles such as silicon dioxide, titanium dioxide, magnesium oxide, calcium carbonate, magnesium carbonate, barium sulfate and strontium sulfate; and organic particles such as polymethyl acrylate, polymethyl methacrylate, polyacrylonitrile, cellulose acetate and cellulose acetate propionate. Especially, organic particles are preferable as lubricants.

Examples of the ultraviolet absorbers may include oxybenzophenone-based compounds, benzotriazole-based compounds, salicylate ester-based compounds, benzophenone-based ultraviolet absorbers, benzotriazole-based ultraviolet absorbers, acrylonitrile-based ultraviolet absorbers, triazin-based compounds, nickel complex salt-based compounds and inorganic powders. Examples of the suitable ultraviolet absorbers may include 2,2′-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2,4-di-tert-butyl-6-(5-chlorobenzotriazole-2-yl)phenol, 2,2′-dihydroxy-4,4′-dimethoxybenzophenone, and 2,2′,4,4′-tetrahydroxybenzophenone. Particularly suitable examples of the ultraviolet absorbers may include 2,2′-methylenebis(4-(1,1,3,3-tetramethylbutyl)-6-(2H-benzotriazole-2-yl)phenol.

[1-4. Physical Properties of Resin Composition]

Since the copolymer (B) contains a maleic acid anhydride unit, the resin composition of the present invention has a high glass transition temperature. Therefore, by using the resin composition of the present invention, it is possible to realize a phase difference film having high heat resistance, i.e., a phase difference film which has low tendency to cause retardation change by heat. Although the specific range of the glass transition temperature may be set depending on the level of heat resistance required in the phase difference film, the range is usually equal to or higher than 115° C., preferably equal to or higher than 120° C., and more preferably equal to or higher than 125° C. Also, although the upper limit of the glass transition temperature is not particularly limited, the upper limit is usually equal to or lower than 200° C.

The resin composition of the present invention also has low haze. This is considered as an advantage obtained by limiting the amount of maleic acid anhydride unit contained in the copolymer (B) within the aforementioned range. In general, a copolymer containing a styrene compound unit and a maleic acid anhydride unit has low mixing compatibility with the polyphenylene ether. Therefore, it was difficult to obtain a resin composition having low haze by mixing of these component. However, according to the studies by the inventor, it has been found out that, if the ratio of the maleic acid anhydride unit in the copolymer (B) is kept in the aforementioned range by adjusting the composition, the polyphenylene ether (A) and the copolymer (B) can be well mixed, so that haze can be lowered to the level suitable as a phase difference film. The specific range of haze may be set depending on the level of transparency required for the phase difference film. As an example, the value of the haze at a thickness of 1 mm is usually equal to or smaller than 10%, preferably equal to or smaller than 5%, and ideally 0%.

[2. Method for Manufacturing Phase Difference Film]

Using the resin composition of the present invention, the phase difference film of the present invention may be manufactured. Usually, the phase difference film of the present invention is obtained by molding the resin composition of the present invention to produce a pre-stretch film, and subjecting the obtained pre-stretch film to a stretching treatment. It is usually preferable that the aforementioned pre-stretch film is manufactured as a long-length film. The “long-length” film herein means a film having a length equal to or greater than five times its width, and preferably having a length equal to or greater than ten times its width. Specifically, a “long-length” film means a film having a length such that the film is capable of being wound up into a roll shape for storage or transportation. Such a long-length film may be obtained by continuously performing a manufacturing process in a manufacturing line in the lengthwise direction. Therefore, when manufacturing the phase difference film of the present invention, a part or whole of steps can be performed in in-line process in a simple and efficient manner.

The method for manufacturing the pre-stretch film may be, e.g., a casting method. However, in terms of manufacturing efficiency, and in order to prevent volatile components such as solvents from remaining in the film, melt extrusion molding is preferable. The melt extrusion molding may be performed by, e.g., a T-die method.

The thickness of the pre-stretch film is preferably equal to or larger than 10 μm and more preferably equal to or larger than 50 μm, and preferably equal to or smaller than 800 μm and more preferably equal to or smaller than 600 μm. By setting the thickness to be equal to or larger than the lower limit value of the aforementioned range, sufficient retardation and mechanical strength can be obtained. By setting the thickness to be equal to or smaller than the upper limit value, favorable flexibility and handling properties can be achieved.

When the obtained pre-stretch film is stretched, the film expresses retardation, and the phase difference film of the present invention is thereby obtained. In this case, the retardation thus expressed is to have inverse wavelength distribution. The mechanism for causing inverse wavelength distribution is inferred as follows.

In the visible region at a wavelength of 400 nm to 700 nm, the wavelength distribution of the polyphenylene ether (A) having a positive intrinsic birefringence value is usually stronger than the wavelength distribution of the copolymer (B) having a negative intrinsic birefringence value. Furthermore, the formulation and other factors of the resin composition of the present invention are adjusted so that the influence of the orientation of the copolymer (B) is slightly larger than the influence of the orientation of the polyphenylene ether (A) on the low wavelength side, and so that the influence of the orientation of the copolymer (B) appears more remarkably as the wavelength approaches to the long wavelength side.

The retardation which is expressed by stretching of the pre-stretch film is usually the sum of the retardation which is expressed by the oriented polyphenylene ether (A) contained in the resin composition of the present invention and the retardation which is expressed by the oriented copolymer (B) contained in the resin composition of the present invention. Accordingly, if the influence of the copolymer (B) is adjusted in the aforementioned manner, i.e., the influence is adjusted such that the influence increases as the wavelength approaches to the long wavelength side, a phase difference film having inverse wavelength distribution can be obtained.

Examples of a stretching operation to be employed may include a method of uniaxially stretching in a lengthwise direction by utilizing a difference in peripheral speed between rolls (longitudinal uniaxial stretching); a method of uniaxially stretching in a width direction by utilizing a tenter (transverse uniaxial stretching); a method of sequentially performing longitudinal uniaxial stretching and transverse uniaxial stretching (sequential biaxial stretching); and a method of stretching in a diagonal direction with respect to the lengthwise direction of a pre-stretch film (diagonal stretching). Among them, it is preferable to employ diagonal stretching. By diagonal stretching, a long-length phase difference film having a slow axis in a diagonal direction is usually obtained. Therefore, amount of waste can be reduced even when a rectangular product is cut out from the long-length stretched film, and a phase difference film having a large area size can thus be efficiently manufactured. The “diagonal direction” herein means a direction which is neither parallel nor orthogonal thereto.

Specific examples of the diagonal stretching method may include a stretching method using a tenter stretching machine. Examples of such a tenter stretching machine may include a tenter stretching machine in which feeding force, tensile force or take-up force can be applied at a different speed on the left and right of the pre-stretch film. The left and right of the pre-stretch film herein mean the left and right that are both ends in a film width direction when a horizontally-fed pre-stretch film is observed from the MD direction. Another example of the tenter stretching machine may be a tenter stretching machine which can achieve stretching in a diagonal direction by applying feeding force, tensile force or take-up force at the same speed on the left and right in the TD direction or in the MD direction with the same traveling distance on the left and right in a non-linear path. Furthermore, still another example may be a tenter stretching machine in which stretching in a diagonal direction can be achieved by the different traveling distances on left and right.

When stretching in a diagonal direction is performed, it is preferable that stretching is performed in such a direction that an angle formed by the stretching direction with respect to the lengthwise direction of a pre-stretch film becomes equal to or larger than 40° and equal to or smaller than 50°. By this stretching, a phase difference film having an orientation angle which is equal to or larger than 40° and equal to or smaller than 50° with respect to the lengthwise direction can be obtained. The “orientation angle” herein is an angle formed between the MD direction of a long-length phase difference film and the in-plane slow axis of the phase difference film.

The film temperature at stretching is preferably Tg to Tg+30° C., and more preferably Tg to Tg+20° C., wherein Tg is the glass transition temperature of the resin composition of the present invention. The stretching ratio may be, e.g., 1.2 to 3 times.

The number of performing stretching operation may be one, or two or more.

Furthermore, when manufacturing the phase difference film of the present invention, a step other than the aforementioned ones may also be performed. For example, before being stretched, the pre-stretch film may be subjected to a preheating treatment.

The obtained phase difference film may also be subjected to a fixing treatment. The temperature for the fixing treatment is usually equal to or higher than the room temperature and preferably equal to or higher than “stretching temperature−40° C.,” and usually equal to or lower than “stretching temperature+30° C.” and preferably equal to or lower than “stretching temperature+20° C.”

Furthermore, if necessary, in order to improve protection and handling properties of the phase difference film, other films such as a masking film may be laminated to the phase difference film.

In the aforementioned example, a configuration in which a single-layer pre-stretch film obtained by melt extrusion-molding the resin composition of the present invention is stretched to produce a single-layer phase difference film has been described. However, as long as the effect of the present invention is not significantly impaired, the pre-stretch film and the phase difference film may be manufactured as a multilayer film including two or more layers. Specific examples thereof may include a multilayer film including two or more layers consisting of the resin composition of the present invention, and a multilayer film including a layer consisting of the resin composition of the present invention and a layer consisting of a resin other than the resin composition of the present invention which does not express retardation under the aforementioned stretching conditions.

[3. Phase Difference Film]

The phase difference film of the present invention consists of the resin composition of the present invention. The phase difference film of the present invention is usually a long-length phase difference film. Since the resin composition of the present invention has high glass transition temperature, the phase difference film of the present invention has an improved heat resistance better than conventional phase difference films. That is, since the phase difference film of the present invention has low tendency to cause orientation relaxation upon application of heat, the film has low tendency to cause retardation change by temperature increase, and can thereby be stably used even at high temperature.

The phase difference film of the present invention usually satisfies the relationship of Re₄₅₀<Re₅₅₀<Re₆₅₀, wherein Re₄₅₀ is an in-plane direction retardation at light having a wavelength of 450 nm, Re₅₅₀ is an in-plane direction retardation at light having a wavelength of 550 nm, and Re₆₅₀ is an in-plane direction retardation at light having a wavelength of 650 nm. This means that the phase difference film of the present invention usually has inverse wavelength distribution. When the phase difference film of the present invention is applied to a liquid crystal display device, the inverse wavelength distribution thus possessed by the film can reduce color tone change due to viewing angles, and can provide effects such as retardation correction uniformly in a wide range of wavelength.

Regarding this matter, Re₄₅₀/Re₅₅₀ is preferably equal to or lower than 0.95, and more preferably equal to or lower than 0.90. Re₆₅₀/Re₅₅₀ is preferably equal to or higher than 1.05, and more preferably equal to or higher than 1.10. By having Re₄₅₀, Re₅₅₀ and Re₆₅₀ that satisfy the aforementioned relationship, effects such as retardation correction in a wide range of wavelength can be obtained equal to or higher than 0.80, and the upper limit of Re₆₅₀/Re₅₅₀ is usually equal to or lower than 1.20.

Furthermore, it is preferable that the in-plane direction retardation at a measurement wavelength of 550 nm of the phase difference film of the present invention is equal to or higher than 110 nm and equal to or lower than 150 nm. By having such retardation, the phase difference film of the present invention can function as a quarter wave plate, and can be applied to, e.g., a circular polarizing plate.

The in-plane direction retardation at each measurement wavelength (Re₄₅₀, Re₅₅₀ and Re₆₅₀) herein is a value represented by |nx−ny|×d. The thickness direction retardation herein is a value represented by {|nx+ny|/2−nz}×d. “nx” herein represents a refractive index in a direction which is orthogonal to the thickness direction (in-plane direction) and which gives the largest refractive index. “ny” represents a refractive index in a direction which is orthogonal to the thickness direction (in-plane direction) and orthogonal to the direction of nx. “nz” represents a refractive index in the thickness direction. “d” represents a film thickness.

The long-length phase difference film of the present invention usually has an orientation angle in a range equal to or larger than 40° and equal to or smaller than 50° with respect to the lengthwise direction. When the phase difference film is cut into a rectangular shape piece to manufacture a product, the product is often required to have a slow axis in the diagonal direction relative to the direction of the rectangular side. In such a case, if the orientation angle is in the range equal to or larger than 40° and equal to or smaller than 50° with respect to the lengthwise direction, the rectangular product can be cut out from the long-length phase difference film simply by cutting out the rectangular film piece with its side being in the direction parallel to or orthogonal to the lengthwise direction, whereby efficient manufacture can be performed and area size can be easily enlarged.

The total light transmittance of the phase difference film of the present invention is preferably equal to or higher than 85%, and more preferably equal to or higher than 92%, in terms of being suitable as an optical film. The total light transmittance is a mean value calculated from measurements of total light transmittance at five locations using a “Haze meter NDH-300A” manufactured by Nippon Denshoku Industries Co., Ltd. in accordance with JIS K7361-1997.

The haze of the phase difference film of the present invention is preferably equal to or lower than 1%, more preferably equal to or lower than 0.8%, and particularly preferably equal to or lower than 0.5%. By setting the haze at a low value, the clarity of a display image on a display device equipped with the phase difference film of the present invention can be improved. The haze is a mean value calculated from measurements at five locations using a “Haze meter NDH-300A” manufactured by Nippon Denshoku Industries Co., Ltd. in accordance with JIS K7361-1997.

ΔYI of the phase difference film of the present invention is preferably equal to or lower than 5, and more preferably equal to or lower than 3. When ΔYI falls in the aforementioned range, coloring does not occur, and visibility can become favorable. ΔYI is an arithmetic mean of values obtained by performing similar five measurements using a “Spectrophotometer SE2000” manufactured by Nippon Denshoku Industries Co., Ltd. in accordance with ASTM E313.

It is preferable that the phase difference film of the present invention has a JIS pencil hardness of HB or harder. This JIS pencil hardness may be adjusted by, e.g., adjusting the layer thickness of resin. The JIS pencil hardness is determined by scratching the surface of a film with pencils in accordance with JIS K5600-5-4. Scratching is performed with pencils with a variety of hardness which are inclined at the angle of 45° to which 500 gram force of downward load is applied. The hardness is determined as the pencil that begins to create scratches.

The thermal shrinkage ratio of the phase difference film of the present invention is preferably equal to or lower than 0.5%, and more preferably equal to or lower than 0.3%. The thermal shrinkage ratio may be expressed as a shrinkage when the phase difference film is left to stand in the atmosphere at 120° C. for 30 minutes without tension applied thereto. The shrinkage ratio is obtained by measuring a shrinkage ratio along the stretching direction of the phase difference film that is a stretched film.

The thickness of the phase difference film of the present invention is usually equal to or larger than 5 μm, preferably equal to or larger than 8 μm, more preferably equal to or larger than 10 μm and particularly preferably equal to or larger than 20 μm, and usually equal to or smaller than 500 μm, preferably equal to or smaller than 300 μm, more preferably equal to or smaller than 200 μm and particularly preferably equal to or smaller than 100 μm.

The phase difference film of the present invention may be used as, e.g., an optical film for a liquid crystal display device. For example, the phase difference film of the present invention may be provided as an optical compensation film to a liquid crystal display device. The liquid crystal display device usually includes a liquid crystal panel in which a light incident-side polarizing plate, a liquid crystal cell and a light emission-side polarizing plate are disposed in this order, and a light source which illuminates the liquid crystal panel with light. By disposing the phase difference film of the present invention, e.g., between the liquid crystal cell and the light incident-side polarizing plate, or between the liquid crystal cell and the light emission-side polarizing plate, visibility of the liquid crystal display device can be remarkably improved.

Examples of the driving system for the liquid crystal cell may include an in-plane switching (IPS) mode, a vertical alignment (VA) mode, a multi-domain vertical alignment (MVA) mode, a continuous pinwheel alignment (CPA) mode, a hybrid alignment nematic (HAN) mode, a twisted nematic (TN) mode, a supertwisted nematic (STN) mode and an optical compensated bend (OCB) mode.

In the liquid crystal display device, the phase difference film of the present invention may be bonded to the liquid crystal cell or the polarizing plate. The phase difference film of the present invention may also be bonded to each of two polarizing plates. Furthermore, two or more phase difference films of the present invention may be used. For bonding, a publicly known adhesive may be used.

As the polarizing plate, a polarizing plate consisting of a polarizer and a protective film bonded on both faces of the polarizer may be used. In this case, the phase difference film of the present invention may also be directly bonded to the polarizer in place of the protective film so that the phase difference film of the present invention may be used as a layer having both functions of a phase difference plate and a protective film. By employing such a configuration, a protective film can be omitted, to thereby contribute to reduction in thickness, weight and cost of a liquid crystal display device.

Furthermore, e.g., the phase difference film of the present invention and a circularly polarizing film are combined to form a brightness enhancing film, and the brightness enhancing film may be provided to a liquid crystal display device.

[4. Circular Polarizing Plate]

The circular polarizing plate of the present invention is a long-length circular polarizing plate, and is obtained by laminating the phase difference film of the present invention having an orientation angle in a range equal to or larger than 40° and equal to or smaller than 50° with respect to the lengthwise direction and a long-length polarizing plate having an absorption axis in the lengthwise direction. Since the direction of the slow axis of the phase difference film of the present invention and the direction of the absorption axis of the polarizing plate can be set to form an appropriate angle merely by laminating the phase difference film and the polarizing plate such that the major axis directions thereof are aligned, such a circular polarizing plate can be easily manufactured.

The long-length polarizing plate may be manufactured by, e.g., causing a polyvinyl alcohol film to adsorb iodine or a dichroic dye, and then uniaxially stretching the resultant film in a boric acid bath. The long-length polarizing plate may also be manufactured by, e.g., causing a polyvinyl alcohol film to adsorb iodine or a dichroic dye and stretching the resultant film, and further modifying part of the polyvinyl alcohol units in the molecular chain into the polyvinylene units. Furthermore, as the polarizing plate, e.g., a polarizing plate having a function of separating polarized light into reflected light and transmitted light, such as a grid polarizing plate and a multi-layer polarizing plate, may be used. Among them, a polarizing plate including polyvinyl alcohol is preferable. The polarization degree of a polarizing plate is preferably equal to or higher than 98%, and more preferably equal to or higher than 99%. The thickness (mean thickness) of the polarizing plate is preferably 5 μm to 80 μm.

For laminating the polarizing plate and the phase difference film of the present invention, an adhesive may be used. The adhesive is not particularly limited as long as the adhesive is optically transparent. Examples of the adhesive may include an aqueous adhesive, a solvent-type adhesive, a two-component curable adhesive, an ultraviolet-curable adhesive and a pressure-sensitive adhesive. Among them, an aqueous adhesive is preferable, and a polyvinyl alcohol-based aqueous adhesive is particularly preferable. As the adhesive, one species may be used alone, or two or more thereof may be used in combination at any ratio.

The mean thickness of a layer formed of an adhesive (adhesive layer) is preferably equal to or larger than 0.05 μm and more preferably equal to or larger than 0.1 μm, and preferably equal to or smaller than 5 μm and more preferably equal to or smaller than 1 μm.

Although the method for laminating the phase difference film of the present invention to the polarizing plate is not limited, a preferable method therefor is a method wherein, after applying an adhesive onto one face of the polarizing plate, the polarizing plate and the phase difference film of the present invention are bonded using a roll laminator and the bonded product is then dried. Prior to bonding, the surface of the phase difference film of the present invention may be subjected to a surface treatment such as a corona discharge treatment and a plasma treatment. The time and temperature for drying are appropriately selected depending on the type of the adhesive.

The circular polarizing plate of the present invention may be used as, e.g., an antireflective film. By bonding and attaching the phase difference film side of the circular polarizing plate of the present invention to, e.g., a screen of a display device, reflection of outside light is suppressed, and the display can be prevented from being poorly visible due to an unnecessary reflective image caused by outside light. In addition, since the phase difference film of the present invention has inverse wavelength distribution, use of the circular polarizing plate of the present invention as an antireflective film can reduce coloring on a black display part.

### EXAMPLES

Although the present invention will be specifically described hereinbelow by referring to Examples, the present invention is not limited to the following Examples, and may be arbitrary modified for implementation within a range that does not depart from the scope of claims of the present invention and its equivalents.

[Description of Evaluation Method]

(Method for Measuring Glass Transition Temperature)

The glass transition temperature of a resin composition was measured using a differential scanning calorimeter (EXSTAR6220 manufactured by Seiko Instruments Inc.) with temperature rise of 20° C./min.

(Method for Measuring Haze)

The haze was obtained by performing measurement at five locations using a “Haze meter NDH-300A” manufactured by Nippon Denshoku Industries Co., Ltd. in accordance with JIS K7361-1997, and calculating a mean value thereof.

(Method for measuring Re₄₅₀, Re₅₅₀ and Re₆₅₀, and Nz₄₅₀, Nz₅₅₀ and Nz₆₅₀)

Using AxoScan manufactured by Axometrics Inc., an in-plane direction retardation Re₄₅₀ (unit: nm) and an Nz coefficient Nz₄₅₀ at a measurement wavelength of 450 nm, an in-plane direction retardation Re₅₅₀ and an Nz coefficient Nz₅₅₀ at a measurement wavelength of 550 nm, and an in-plane direction retardation Re₆₅₀ and an Nz coefficient Nz₆₅₀ at a measurement wavelength of 650 nm were measured. The Nz coefficient is a coefficient represented by Nz=(nx−nz)/(nx−ny).

(Method for Measuring High Temperature Resistance)

The film was left stand under dry condition at a temperature of 80° C. for 500 hours, and then Re₅₅₀ was measured. The amount of change of the value from the initial value was taken as an index of high temperature resistance.

(Antireflective Properties and Coloring of Circular Polarizing Plate)

Regarding each phase difference film, a hypothetical film having Nz₄₅₀, Nz₅₅₀ and Nz₆₅₀ which are identical with the aforementioned measured values and also having Re₆₅₀ of 140 nm is assumed. This hypothetical phase difference film and the polarizing plate are disposed such that the slow axis of the phase difference film and the absorption axis of the polarizing plate form an angle of 45°, to thereby form a circular polarizing plate. As the polarizing plate, an absorption-type linear polarizing plate (HLC2-5618ReB manufactured by Sanritz Corporation) is used. Furthermore, a reflector is disposed to the phase difference film side of the circular polarizing plate. The brightness of reflected light of incident light which entered from the polarizing plate side at an azimuth angle of 0 to 360° and at a polar angle of 0 to 80° is calculated by optical simulation using a 4×4 matrix. Low brightness is indicative of good antireflective property.

Color difference (L*a*b display system) between reflected light of incident light which has entered at an azimuth angle of 0 to 360° and at a polar angle of 0 to 80° and reflected light of incident light which has perpendicularly entered at a polar angle of 0° is calculated. Small color difference is indicative of small viewing angle dependence of coloring and thus being favorable.

### Preparative Example 1

### Production of Styrene-Maleic Acid Anhydride Copolymer B1

A complete mixing reactor equipped with a stirrer, a column-type plug flow reactor, and a deaeration vessel equipped with a preheater were connected in series to configure a manufacturing system. A raw material solution was prepared by mixing 85 parts by weight of styrene, 15 parts by weight of maleic acid anhydride, 0.02 parts by weight of 1,1-bis(t-butylperoxy)-cyclohexane, and 0.2 parts by weight of n-dodecyl mercaptan. This raw material solution was poured into the complete mixing reactor which was controlled at a temperature of 130° C., and stirred at 180 rpm. Then, the reaction solution was continuously extracted from the complete mixing reactor, and introduced into the column-type plug flow reactor which was adjusted such that a temperature gradient of 130° C. to 160° C. was provided toward the flow direction. While the obtained reaction solution was heated using the preheater, the reaction solution was introduced into the deaeration vessel which was controlled at a temperature of 235° C. and under a pressure of 1.0 kPa, to remove volatile components such as an unreacted monomer. The obtained resin liquid was extracted using a gear pump, and the extracted resin liquid was extruded in a strand shape and was cut, to thereby obtain a styrene-maleic acid anhydride copolymer B1. The obtained styrene-maleic acid anhydride copolymer B1 had 85% by weight of styrene units and 15% by weight of maleic acid anhydride units. The glass transition temperature of the styrene-maleic acid anhydride copolymer B1 was 125° C.

### Preparative Example 2

### Production of Styrene-Maleic Acid Anhydride Copolymer B2

A styrene-maleic acid anhydride copolymer B2 was obtained in to the same manner as in Preparative Example 1, except that the amount of styrene was 90 parts by weight, and the amount of maleic acid anhydride was 10 parts by weight. The obtained styrene-maleic acid anhydride copolymer B2 had 92% by weight of styrene units and 8% by weight of maleic acid anhydride units. The glass transition temperature of the styrene-maleic acid anhydride copolymer B2 was 102° C.

### Preparative Example 3

### Production of Styrene-Maleic Acid Anhydride Copolymer B3

A styrene-maleic acid anhydride copolymer B3 was obtained in the same manner as in Preparative Example 1, except that the amount of styrene was 80 parts by weight, and the amount of maleic acid anhydride was 20 parts by weight. The obtained styrene-maleic acid anhydride copolymer B3 had 78% by weight of styrene units and 22% by weight of maleic acid anhydride units. The glass transition temperature of the styrene-maleic acid anhydride copolymer B3 was 145° C.

### Preparative Example 4

### Production of Styrene-Maleic Acid Anhydride Copolymer B4

A styrene-maleic acid anhydride copolymer B4 was obtained in the same manner as in Preparative Example 1, except that the amount of styrene was 75 parts by weight, and the amount of maleic acid anhydride was 25 parts by weight. The obtained styrene-maleic acid anhydride copolymer B4 had 74% by weight of styrene units and 26% by weight of maleic acid anhydride units. The glass transition temperature of the styrene-maleic acid anhydride copolymer B4 was 160° C.

### Example 1

### Manufacture of Pre-Stretch Film

79 parts by weight of the styrene-maleic acid anhydride copolymer B1 and 21 parts by weight of poly(2,6-dimethyl-1,4-phenylene oxide) (manufactured by Aldrich) were kneaded using a twin screw extruder, to prepare pellets of a transparent resin composition P1. The glass transition temperature of the obtained resin composition P1 was 143° C.

The pellets of the resin composition P1 were melted using a single screw extruder, supplied to an extrusion die, and extrusion-molded, to obtain a pre-stretch film 1 having a thickness of 200 μm.

(Manufacture and Evaluation of Phase Difference Film)

The pre-stretch film 1 was then diagonally stretched using a tenter stretching machine so that the direction of a slow axis was tilted 45° with respect to the MD direction. The temperature for stretching was 143° C. which was the glass transition temperature of the resin composition P1, and the stretching ratio was set to be 2.0 times. Thus, a long-length phase difference film 1 having a thickness of 100 μm was obtained. The orientation of the obtained phase difference film 1 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 1 were measured in the aforementioned manner. The results are shown in Table 1.

(Manufacture and Evaluation of Antireflective Film)

The phase difference film 1 and a polarizing plate were bonded together with an adhesive (an acrylic acid ester copolymer “SK DYNE 2094” manufactured by Soken Chemical & Engineering Co., Ltd.) by a roll-to-roll process while the MD directions thereof are aligned so that the slow axis of the phase difference film 1 and the absorption axis of the polarizing plate form an angle of 45°. Thus, a circular polarizing plate was prepared.

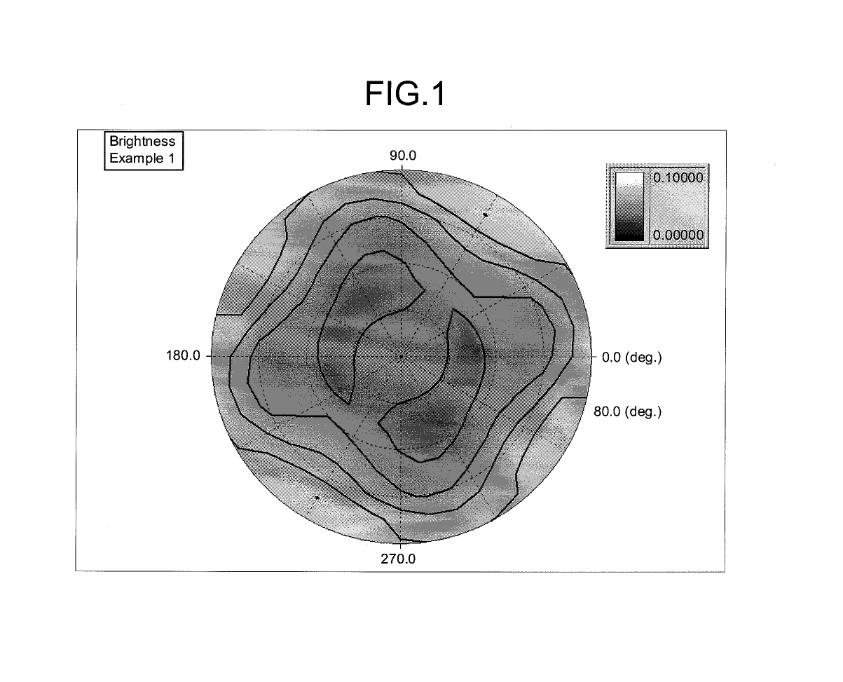

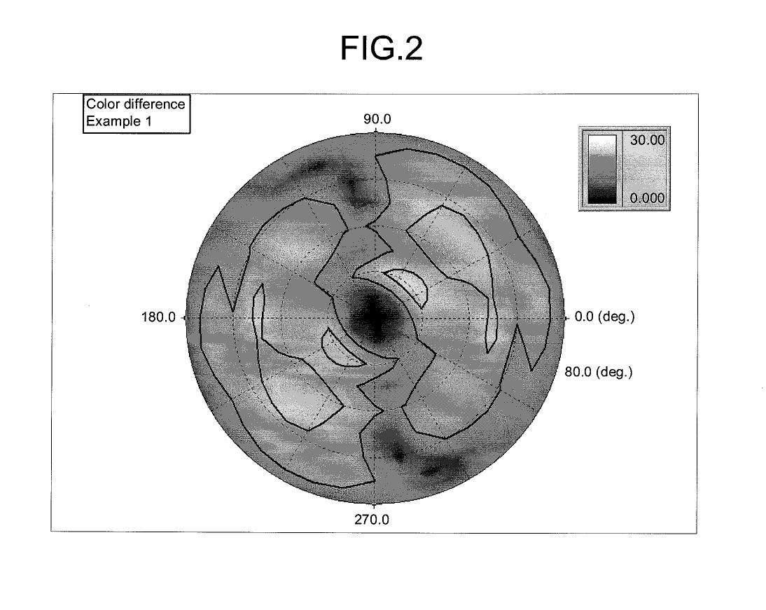

To the phase difference film 1 side of the obtained circular polarizing plate, a glossy ferrotype plate was bonded with an adhesive (an acrylic acid ester copolymer “SK DYNE 2094” manufactured by Soken Chemical & Engineering Co., Ltd.), and reflected light which had entered from the circular polarizing plate side was visually observed. The reflected light was suppressed, and colorless. The calculation results of the brightness of the reflected light are shown in FIG. 1, and the calculation results of the color difference of the reflected light are shown in FIG. 2. It is seen that reflection was suppressed in a wide range of viewing angle, and coloring was minor.

### Example 2

### Manufacture of Pre-Stretch Film

77 parts by weight of the styrene-maleic acid anhydride copolymer B2 and 23 parts by weight of poly(2,6-dimethyl-1,4-phenylene oxide) were kneaded using a twin screw extruder to prepare pellets of a transparent resin composition P2. The glass transition temperature of the obtained resin composition P2 was 127° C. The pellets of the resin composition P2 were melted using a single screw extruder, supplied to an extrusion die, and extrusion-molded, to obtain a pre-stretch film 2 having a thickness of 200 μm.

(Manufacture and Evaluation of Phase Difference Film)

A long-length phase difference film 2 having a thickness of 100 μm was then obtained in the same manner as in Example 1, except that the pre-stretch film 2 was used in place of the pre-stretch film 1, and the temperature for stretching was 127° C. which was the glass transition temperature of the resin composition P2. The orientation of the obtained phase difference film 2 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 2 were measured in the aforementioned manner. The results are shown in Table 1.

(Manufacture and Evaluation of Antireflective Film)

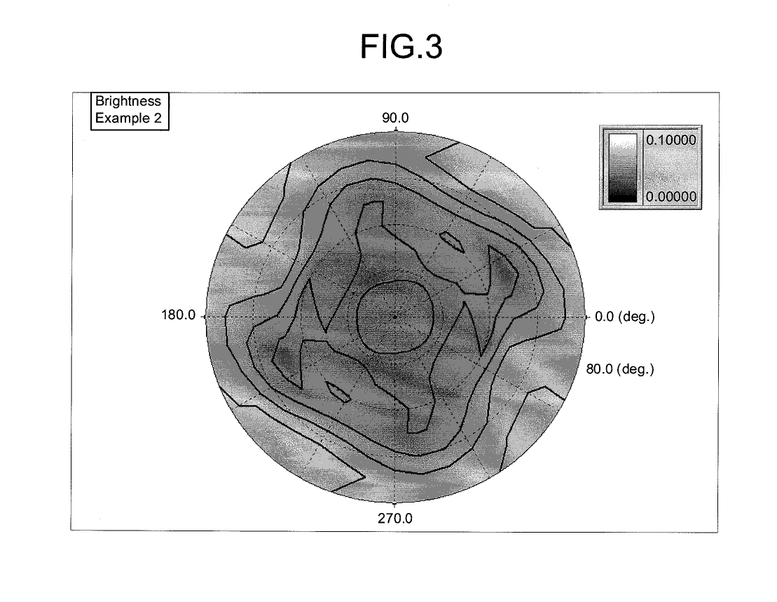

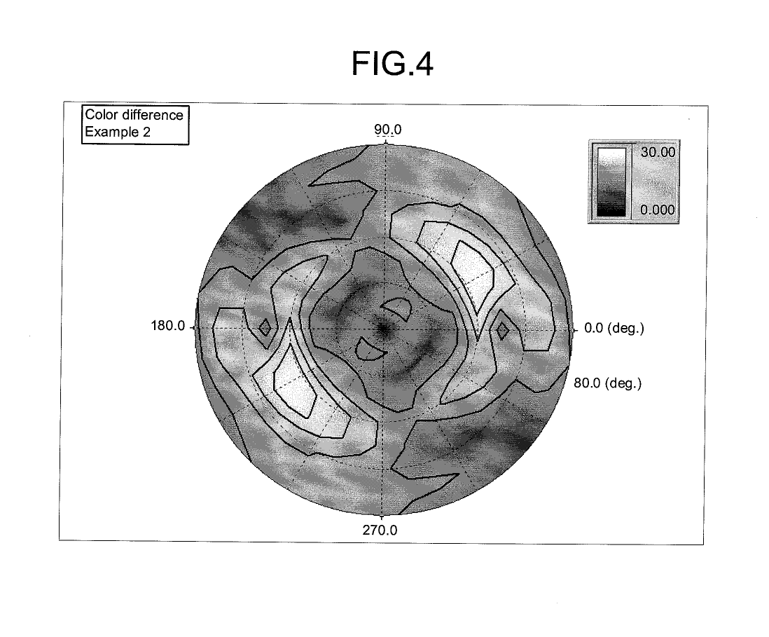

A circular polarizing plate was manufactured in the same manner as in Example 1, except that the phase difference film 2 was used in place of the phase difference film 1. The calculation results of the brightness of the reflected light in the obtained circular polarizing plate are shown in FIG. 3, and the calculation results of the color difference of the reflected light are shown in FIG. 4. It is seen that reflection was suppressed in a wide range of viewing angle, and coloring was minor.

### Example 3

### Manufacture of Pre-Stretch Film

Pellets of a transparent resin composition P3 were prepared in the same manner as in Example 1, except that the amount of the styrene-maleic acid anhydride copolymer B1 was changed to be 81 parts by weight, and the amount of poly(2,6-dimethyl-1,4-phenylene oxide) was changed to be 19 parts by weight. The glass transition temperature of the obtained resin composition P3 was 141° C.

The pellets of the resin composition P3 were melted using a single screw extruder, supplied to an extrusion die, and extrusion-molded, to obtain a pre-stretch film 3 having a thickness of 200 μm.

(Manufacture and Evaluation of Phase Difference Film)

A long-length phase difference film 3 having a thickness of 100 μm was then obtained in the same manner as in Example 1, except that the pre-stretch film 3 was used in place of the pre-stretch film 1, and the temperature for stretching was 141° C. which was the glass transition temperature of the resin composition P3. The orientation of the obtained phase difference film 3 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 3 were measured in the aforementioned manner. The results are shown in Table 1.

(Manufacture and Evaluation of Antireflective Film)

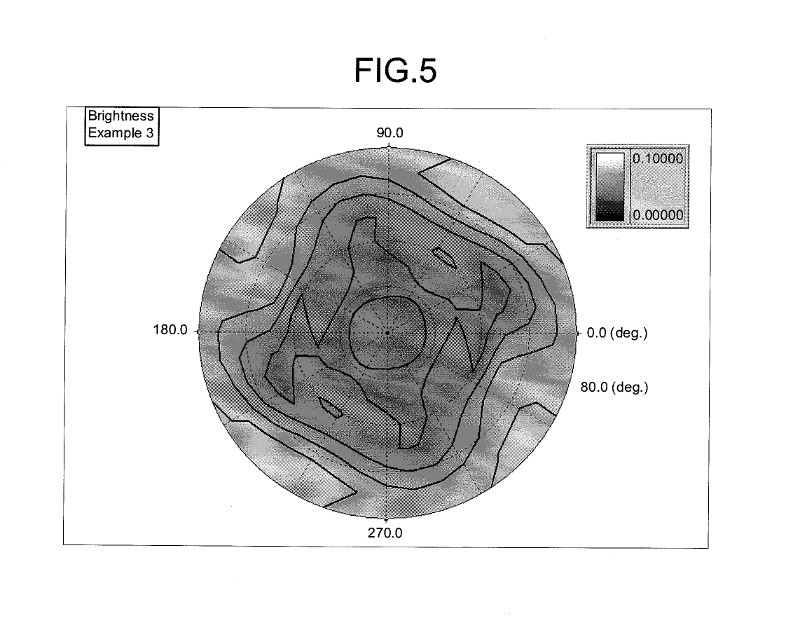

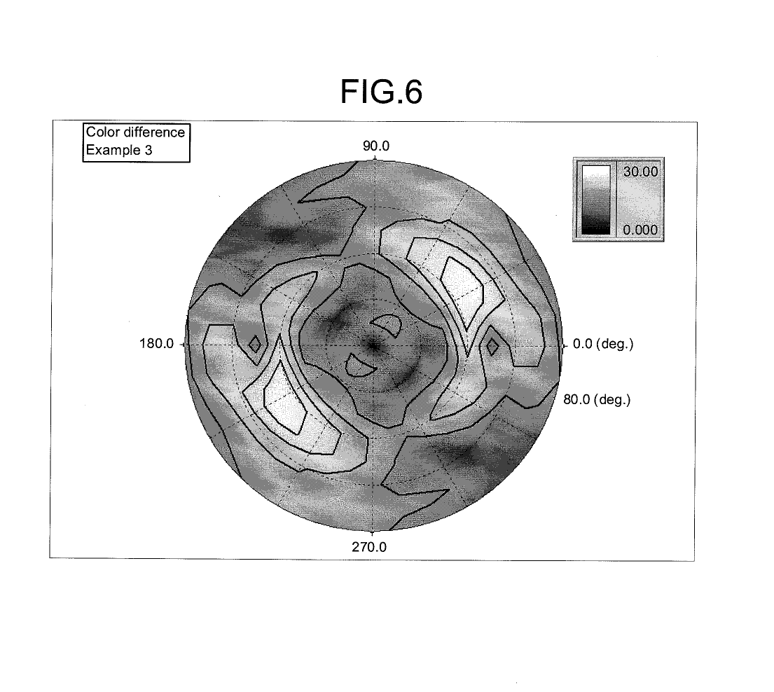

A circular polarizing plate was manufactured in the same manner as in Example 1, except that the phase difference film 3 was used in place of the phase difference film 1. The calculation results of the brightness of the reflected light in the obtained circular polarizing plate are shown in FIG. 5, and the calculation results of the color difference of the reflected light are shown in FIG. 6. It is seen that reflection was suppressed in a wide range of viewing angle, and coloring was minor.

### Comparative Example 1

### Manufacture of Pre-Stretch Film

81 parts by weight of the styrene-maleic acid anhydride copolymer B4 and 19 parts by weight of poly(2,6-dimethyl-1,4-phenylene oxide) were kneaded using a twin screw extruder, to prepare pellets of a transparent resin composition P4. The glass transition temperature of the obtained resin composition P4 was 169° C.

The pellets of the resin composition P4 were melted using a single screw extruder, supplied to an extrusion die, and extrusion-molded, to obtain a pre-stretch film 4 having a thickness of 200 μm.

(Manufacture and Evaluation of Phase Difference Film)

A long-length phase difference film 4 having a thickness of 100 μm was then obtained in the same manner as in Example 1, except that the pre-stretch film 4 was used in place of the pre-stretch film 1, and the temperature for stretching was 169° C. which was the glass transition temperature of the resin composition P4. The orientation of the obtained phase difference film 4 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 4 were measured in the aforementioned manner. The results are shown in Table 1. The phase difference film had high haze and poor transparency, and was not suitable as an optical film.

### Comparative Example 2

### Manufacture of Pre-Stretch Film

80 parts by weight of the styrene-maleic acid anhydride copolymer B3 and 20 parts by weight of poly(2,6-dimethyl-1,4-phenylene oxide) were kneaded using a twin screw extruder, to prepare pellets of a transparent resin composition P5. The glass transition temperature of the obtained resin composition P5 was 158° C.

The pellets of the resin composition P5 were melted using a single screw extruder, supplied to an extrusion die, and extrusion-molded, to obtain a pre-stretch film 5 having a thickness of 200 μm.

(Manufacture and Evaluation of Phase Difference Film)

A long-length phase difference film 5 having a thickness of 100 μm was then obtained in the same manner as in Example 1, except that the pre-stretch film 5 was used in place of the pre-stretch film 1, and the temperature for stretching was 158° C. which was the glass transition temperature of the resin composition P5. The orientation of the obtained phase difference film 5 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 5 were measured in the aforementioned manner. The results are shown in Table 1. The phase difference film had high haze and poor transparency, and was not suitable as an optical film.

### Comparative Example 3

### Manufacture of Pre-Stretch Film

75 parts by weight of polystyrene and 25 parts by weight of poly(2,6-dimethyl-1,4-phenylene oxide) were kneaded using a twin screw extruder to prepare pellets of a transparent resin composition P6. The glass transition temperature of the obtained resin composition P6 was 111° C.

The pellets of the resin composition P6 were melted using a single screw extruder, supplied to an extrusion die, and extrusion-molded, to obtain a pre-stretch film 6 having a thickness of 200 μm.

(Manufacture and Evaluation of Phase Difference Film)

A long-length phase difference film 6 having a thickness of 100 μm was then obtained in the same manner as in Example 1, except that the pre-stretch film 6 was used in place of the pre-stretch film 1, and the temperature for stretching was 111° C. which was the glass transition temperature of the resin composition P6. The orientation of the obtained phase difference film 6 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 6 were measured in the aforementioned manner. The results are shown in Table 1. It is seen that the phase difference film was poor in high temperature resistance.

### Comparative Example 4

### Manufacture of Pre-Stretch Film

Pellets of a transparent resin composition P7 were prepared in the same manner as in Example 1, except that the amount of the styrene-maleic acid anhydride copolymer B1 was changed to be 83 parts by weight, and the amount of poly(2,6-dimethyl-1,4-phenylene oxide) was changed to be 17 parts by weight. The glass transition temperature of the obtained resin composition P7 was 139° C.

The pellets of the resin composition P7 were melted using a single screw extruder, supplied to an extrusion die, and extrusion-molded, to obtain a pre-stretch film 7 having a thickness of 200 μm.

(Manufacture and Evaluation of Phase Difference Film)

A long-length phase difference film 7 having a thickness of 100 μm was then obtained in the same manner as in Example 1, except that the pre-stretch film 7 was used in place of the pre-stretch film 1, and the temperature for stretching was 139° C. which was the glass transition temperature of the resin composition P7. The orientation of the obtained phase difference film 7 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 7 were measured in the aforementioned manner. The results are shown in Table 1.

(Manufacture and Evaluation of Antireflective Film)

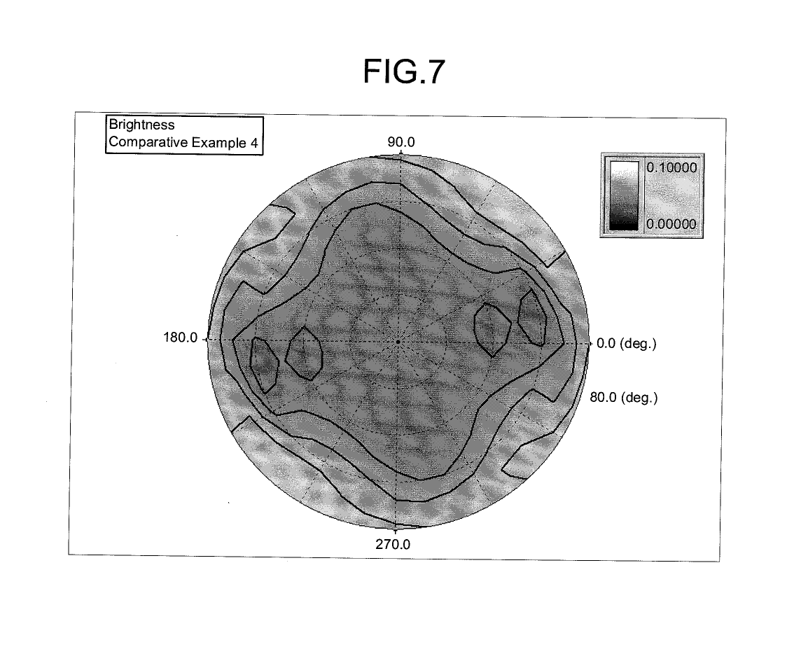

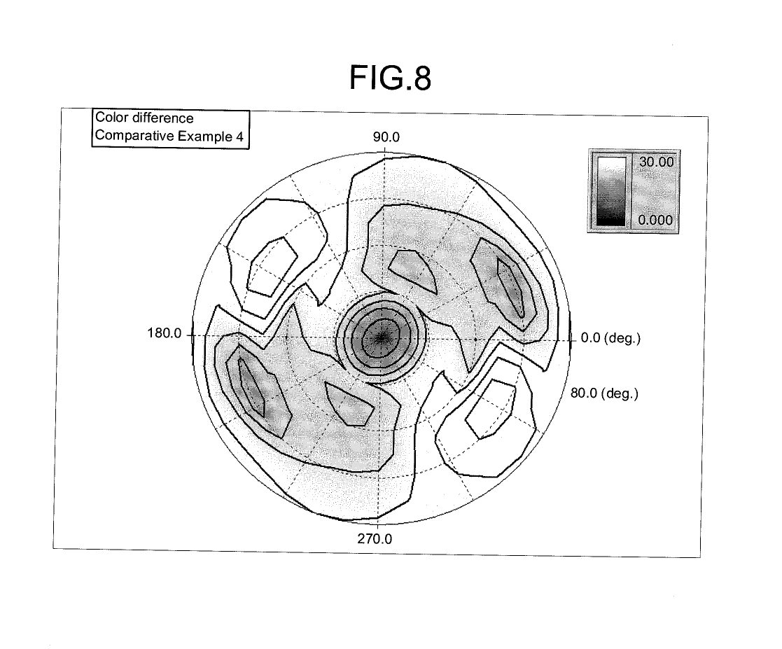

A circular polarizing plate was manufactured in the same manner as in Example 1, except that the phase difference film 7 was used in place of the phase difference film 1. The calculation results of the brightness of the reflected light in the obtained circular polarizing plate are shown in FIG. 7, and the calculation results of the color difference of the reflected light are shown in FIG. 8. It is seen that coloring is stronger than Examples when the polar angle is large.

### Comparative Example 5

### Manufacture of Pre-Stretch Film

Pellets of a transparent resin composition P8 were prepared in the same manner as in Example 1, except that the amount of the styrene-maleic acid anhydride copolymer B1 was changed to be 76 parts by weight, and the amount of poly(2,6-dimethyl-1,4-phenylene oxide) was changed to be 24 parts by weight. The glass transition temperature of the obtained resin composition P8 was 145° C. The pellets of the resin composition P8 were melted using a single screw extruder, supplied to an extrusion die, and extrusion-molded, to obtain a pre-stretch film 8 having a thickness of 200 μm.

(Manufacture and Evaluation of Phase Difference Film)

A long-length phase difference film 8 having a thickness of 100 μm was then obtained in the same manner as in Example 1, except that the pre-stretch film 8 was used in place of the pre-stretch film 1, and the temperature for stretching was 145° C. which was the glass transition temperature of the resin composition P8. The orientation of the obtained phase difference film 8 was examined. As a result, it was found out that the slow axis was tilted 45° with respect to the MD direction. The haze, high temperature resistance and in-plane direction retardation Re₄₅₀, Re₅₅₀ and Re₆₅₀ of the obtained phase difference film 8 were measured in the aforementioned manner. The results are shown in Table 1.

(Manufacture and Evaluation of Antireflective film)

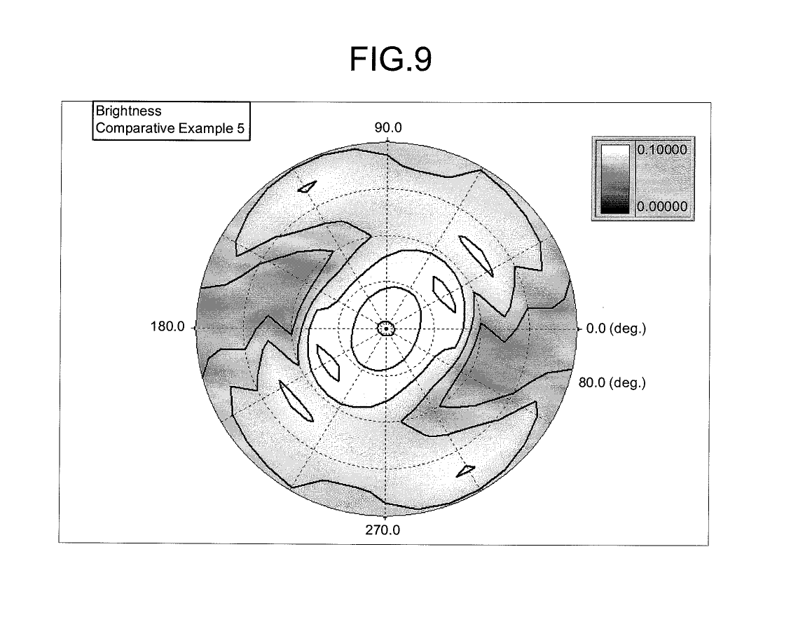

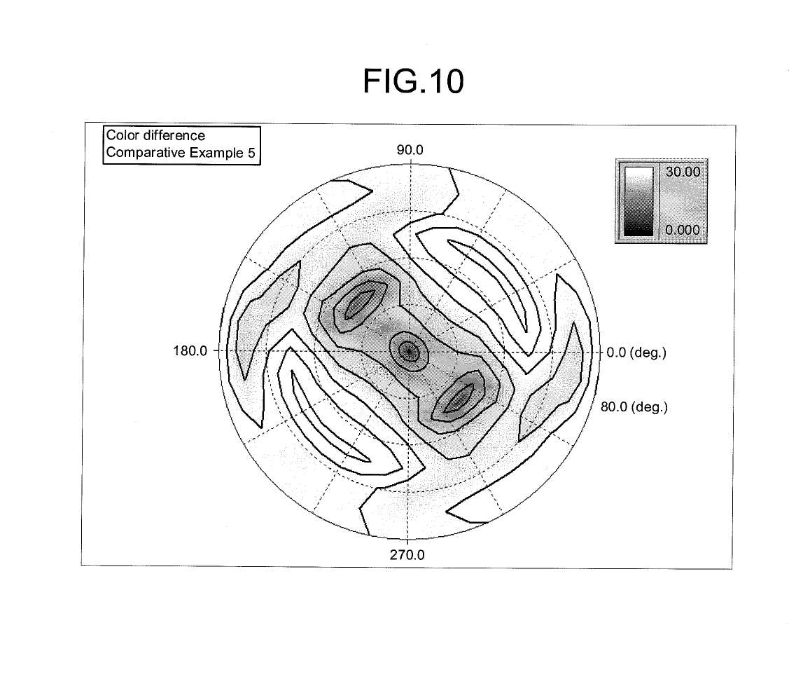

A circular polarizing plate was manufactured in the same manner as in Example 1, except that the phase difference film 8 was used in place of the phase difference film 1. The calculation results of the brightness of the reflected light in the obtained circular polarizing plate are shown in FIG. 9, and the calculation results of the color difference of the reflected light are shown in FIG. 10. When compared with Examples, it is seen that reflected light is strong, and coloring is strong when the polar angle is large.

TABLE 1
Evaluation results of phase difference films

| | | | | | Comp. | Comp. | Comp. | Comp. | Comp. |
|---|---|---|---|---|---|---|---|---|---|
| | | Ex. 1 | Ex. 2 | Ex. 3 | Ex. 1 | Ex. 2 | Ex. 3 | Ex. 4 | Ex. 5 |
| Amount of | | 0.21 | 0.23 | 0.19 | 0.19 | 0.20 | 0.25 | 0.17 | 0.24 |
| polyphenylene | | | | | | | | | |
| ether (A) | | | | | | | | | |
| Copolymer | Containing | 0.15 | 0.08 | 0.15 | 0.26 | 0.22 | 0.00 | 0.15 | 0.15 |
| (B) | ratio of | | | | | | | | |
| | maleic | | | | | | | | |
| | acid | | | | | | | | |
| | anhydride | | | | | | | | |
| | unit in | | | | | | | | |
| | copolymer | | | | | | | | |
| | (B) | | | | | | | | |
| | Containing | 0.85 | 0.92 | 0.85 | 0.74 | 0.78 | 1.00 | 0.85 | 0.85 |
| | ratio of | | | | | | | | |
| | styrene | | | | | | | | |
| | compound | | | | | | | | |
| | unit in | | | | | | | | |
| | copolymer | | | | | | | | |
| | (B) | | | | | | | | |
| Amount of | | 31.3 | 32.5 | 27.6 | 31.7 | 32.1 | 33.3 | 24.1 | 37.2 |
| polyphenylene | | | | | | | | | |
| ether (A) | | | | | | | | | |
| relative to 100 | | | | | | | | | |
| parts of styrene | | | | | | | | | |
| compound units | | | | | | | | | |
| (parts) | | | | | | | | | |
| Haze (%) | | 0.41 | 0.03 | 0.31 | 15.26 | 1.15 | 0.03 | 0.31 | 0.03 |
| Glass transition | | 143 | 127 | 141 | 169 | 158 | 111 | 139 | 145 |
| temperature of | | | | | | | | | |
| resin | | | | | | | | | |
| composition (° C.) | | | | | | | | | |
| Phase | 450 nm | 127 | 102 | 191 | 145 | 116 | 79 | 223 | 10 |
| difference | 550 nm | 140 | 118 | 196 | 162 | 131 | 95 | 222 | 4 |
| (nm) | 650 nm | 146 | 125 | 198 | 170 | 138 | 102 | 221 | 2 |
| Nz | 450 nm | −0.15 | −0.14 | −0.13 | −0.15 | −0.14 | −0.13 | −0.14 | 1.12 |
| coefficient | 550 nm | −0.14 | −0.13 | −0.12 | −0.15 | −0.13 | −0.13 | −0.14 | 1.13 |
| | 650 nm | −0.14 | −0.12 | −0.12 | −0.14 | −0.13 | −0.12 | −0.13 | −0.14 |

| | | | | | | | | |
|---|---|---|---|---|---|---|---|---|
| Phase difference | 139 | 116 | 195 | 161 | 131 | 89 | 220 | 4 |
| at wavelength of | | | | | | | | |
| 550 nm after 80° C. × | | | | | | | | |
| 500 hours (nm) | | | | | | | | |

[Discussion]

As seen in Table 1, in Examples 1 to 3, the glass transition temperature of the resin composition increased when compared with Comparative Example 3 in which the copolymer (B) did not contain a maleic acid anhydride component. Therefore, the phase difference films in Examples 1 to 3 have excellent heat resistance. It is considered that these films have low tendency to cause orientation relaxation and low tendency to cause retardation change even, e.g., under high temperature environment of 80° C.

In Comparative Examples 1 and 2 as well as in Comparative Examples 4 and 5, the glass transition temperature of the resin composition was improved compared with Comparative Example 3. However, haze was high (Comparative Examples 1 and 2), or no inverse wavelength distribution was provided (Comparative Examples 4 and 5). On the other hand, in each of Examples 1 to 3, haze was low, and inverse wavelength distribution was expressed.

From the aforementioned results, it was confirmed that a phase difference film having inverse wavelength distribution, high transparency, and improved heat resistance that is better than the heat resistance of conventional phase difference films can be realized by the configuration of the present invention. It was also confirmed that, according to the present invention, a circular polarizing plate in which reflection is suppressed in a wide range of viewing angle and coloring is minor can be obtained.

1. A phase difference film consisting of a resin composition comprising: a polyphenylene ether (A); and a copolymer (B) containing a repeating unit derived from a styrene compound and a repeating unit derived from maleic acid anhydride, wherein
an amount of the repeating unit derived from maleic acid anhydride in the copolymer (B) is equal to or larger than 5% by weight and equal to or smaller than 20% by weight, and
an amount of the polyphenylene ether (A) is equal to or more than 25 parts by weight and equal to or less than 35 parts by weight with respect to 100 parts by weight of the repeating unit derived from the styrene compound.

2. (canceled)

3. (canceled)

4. The phase difference film according to claim 1, wherein
the phase difference film has a long length, and
the phase difference film has an orientation angle in a range equal to or larger than 40° and equal to or smaller than 50° with respect to a lengthwise direction of the phase difference film.

5. The phase difference film according to claim 1,
wherein an in-plane direction retardation Re at a measurement wavelength of 550 nm is equal to or larger than 110 nm and equal to or smaller than 150 nm.

6. The phase difference film according to claim 1, wherein;
Re₄₅₀, being an in-plane direction retardation of light having a wavelength of 450 nm,
Re₅₅₀, being an in-plane direction retardation of light having a wavelength of 550 nm, and
Re₆₅₀, being an in-plane direction retardation of light having a wavelength of 650 nm satisfy a relationship of Re₄₅₀<Re₅₅₀<Re₆₅₀.

7. A method for manufacturing the phase difference film according to claim 1, the method comprising stretching a pre-stretch film, the pre-stretch film being obtained by molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.

8. A method for manufacturing the phase difference film according to claim 4, the method comprising stretching a long-length pre-stretch film in a diagonal direction with respect to a lengthwise direction of the long-length pre-stretch film, the long-length pre-stretch film being obtained by melt extrusion-molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.

9. A long-length circular polarizing plate, obtained by laminating the long-length phase difference film according to claim 4 and a long-length polarizing plate having an absorption axis in a lengthwise direction.

10. The phase difference film according to claim 4, wherein;
Re₄₅₀, being an in-plane direction retardation of light having a wavelength of 450 nm,
Re₅₅₀, being an in-plane direction retardation of light having a wavelength of 550 nm, and
Re₆₅₀, being an in-plane direction retardation of light having a wavelength of 650 nm satisfy a relationship of Re₄₅₀<Re₅₅₀<Re₆₅₀.

11. A method for manufacturing the phase difference film according to claim 4, the method comprising stretching a pre-stretch film, the pre-stretch film being obtained by molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.

12. The phase difference film according to claim 5, wherein;
Re₄₅₀, being an in-plane direction retardation of light having a wavelength of 450 nm,
Re₅₅₀, being an in-plane direction retardation of light having a wavelength of 550 nm, and
Re₆₅₀, being an in-plane direction retardation of light having a wavelength of 650 nm satisfy a relationship of Re₄₅₀<Re₅₅₀<Re₆₅₀.

13. A method for manufacturing the phase difference film according to claim 5, the method comprising stretching a pre-stretch film, the pre-stretch film being obtained by molding a resin composition, the resin composition including a polyphenylene ether (A) and a copolymer (B) containing a repeating unit derived from a styrene compound and a repeating unit derived from maleic acid anhydride, wherein an amount of the repeating unit derived from maleic acid anhydride in the copolymer (B) is equal to or larger than 5% by weight and equal to or smaller than 20% by weight, and an amount of the polyphenylene ether (A) is equal to or more than 25 parts by weight and equal to or less than 35 parts by weight with respect to 100 parts by weight of the repeating unit derived from the styrene compound.
